(19) United States
(12) Patent Application Publication
(10) Pub. No.: US 2015/0112819 A1
(43) Pub. Date: Apr. 23, 2015

(54) LOCAL AREA SOCIAL NETWORK

(71) Applicant: GREG STUDLEY, ASPEN, CO (US)

(72) Inventor: GREG STUDLEY, ASPEN, CO (US)

(21) Appl. No.: 14/309,606

(22) Filed: Jun. 19, 2014

Related U.S. Application Data
(60) Provisional application No. 61/894,245, filed on Oct. 22, 2013.

(51) Int. Cl. G06Q 30/02; G06Q 50/00

(52) U.S. Cl. CPC G06Q 30/0277; G06Q 50/01
USPC 705/14.73

(57) ABSTRACT

A local area social network is configured to enable a plurality of computer peripheral devices to show display data on a single shared screen. The local area social network has a proprietary network configured within a local venue. The single shared screen communicatively coupled to the proprietary network. A first computer peripheral device is communicatively coupled to the proprietary network such that the display data sent from the first computer peripheral device is displayed on the single shared screen. A second computer peripheral device is communicatively coupled to the proprietary network such that communication data from the second computer peripheral device is displayed on the first computer peripheral device. A web server is communicatively coupled to the proprietary network wherein the web server pushes data to the single shared screen and pulls user data sent from the first computer peripheral device and the second computer peripheral device.

### RELATED APPLICATION

This application claims priority to provisional patent application U.S. Ser. No. 61/894,245 filed on Oct. 22, 2013, the entire contents of which is herein incorporated by reference.

### BACKGROUND

The Internet comprises mainly web servers and clients. A web server is a computer that delivers (serves up) hypertext mark-up language (HTML) pages. Every web server has an internet protocol (IP) address and possibly a domain name. If a client requests a resource via a uniform resource locator/identifier (URL/URI) a request is sent to a server corresponding to the URL/URI.

A web document is a representation of information in a description language like HTML, or XHTML, that is dedicated to be transferable (according to a certain protocol) from a server to a client and that (the information) could be rendered, i.e. presented, at the client.

Hypertext transfer protocol (HTTP) is the underlying protocol used by the server and the client. HTTP defines how messages are formatted and transmitted, and what actions a web server and client should take in response to various commands. For example, when requesting a URL in at a client, this actually sends an HTTP command to the web server directing it to fetch and transmit the requested page.

The other main standard that controls how the World Wide Web works is hypertext markup language (HTML), which governs how web pages are formatted and displayed. HTTP is called a stateless protocol because each command is executed independently, without any knowledge of the commands that came before it.

The embodiments herein relate generally to systems which engage individuals in a group setting. Prior to embodiments of the disclosed invention, there was no efficient system for using social media to communicate with proximately located individuals. The prior art includes: U.S. Patent Application Publication 2013/0117390 filed by Etchegoyen; U.S. Patent Application Publication 2013/0212199 filed by Ekberg; U.S. Patent Application Publication 2013/0006749 filed by Fink; U.S. Patent Application Publication 2011/0307399 filed by Holmes; U.S. Patent Application Publication 2011/0271213 filed by Newman; and U.S. Patent Application Publication 2011/0238755 filed by Khan.

Etchegoyn, Khan and Fink teach a local area social networking server limits social networking activity to people likely to be in close physical proximity to one another and likely to be engaged in similar activities, even people previously unknown to each other. Etchegoyn does this by only permitting social networking between computing devices that are connected to one another through a common local area network.

Holmes and Ekberg teach a social network involving making a user profile and sharing messages displayed on a welcome page or event profile page. Fink teaches event-based sharing of audio/video in real-time along with chat text by anyone capturing or viewing the shared video.

However, none of the references teach placing messages on a single shared screen. Embodiments of the disclosed invention solve this problem.

### SUMMARY

A local area social network is configured to enable a plurality of computer peripheral devices to show display data on a single shared screen. The local area social network has a proprietary network configured within a local venue. The single shared screen communicatively coupled to the proprietary network. A first computer peripheral device is communicatively coupled to the proprietary network such that the display data sent from the first computer peripheral device is displayed on the single shared screen. A second computer peripheral device is communicatively coupled to the proprietary network such that communication data from the second computer peripheral device is displayed on the first computer peripheral device. A web server is communicatively coupled to the proprietary network wherein the web server pushes data to the single shared screen and pulls user data sent from the first computer peripheral device and the second computer peripheral device.

In some embodiments, a website can be hosted on the web server wherein advertisers purchase advertisements that are pushed to the single shared screen. A filter configured within the web server or the proprietary network can censor obscene or inappropriate material, as defined by the local venue, which is not displayed on the single shared screen. A computer application can be downloaded on to the first computer peripheral device and the second computer peripheral device to facilitate an exchange of the display data and the communication data.

A locking out feature in the web server can be configured to prevent operation of the proprietary network when fees are not paid. A reward feature in the web server can be configured to enable a first user to encourage a second user for sending the display data.

A non-transitory computer readable medium can be configured with processor instructions to be executed by a processor on a first computer peripheral device. The processor instructions can include creating a profile with brief personal information; concealing at least some of the brief personal information with privacy settings. Next, connecting to a proprietary network within a local venue. Then, connecting to a second computer peripheral device on the proprietary network; sending communication data to the second computer peripheral device. After that, connecting to a single shared screen that is shared by the first computer peripheral device and the second computer peripheral device; and sending display data to the single shared screen. In some embodiments the processor instructions can include rewarding a user of the second computer peripheral device for submitting the display data to the single shared screen.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic view of one embodiment of the present invention;

FIG. 2 shows a schematic view of one embodiment of the present invention;

FIG. 3 shows a schematic view of one embodiment of the present invention; and

FIG. 4 shows a schematic view of one embodiment of the present invention.

### DETAILED DESCRIPTION OF CERTAIN EMBODIMENTS

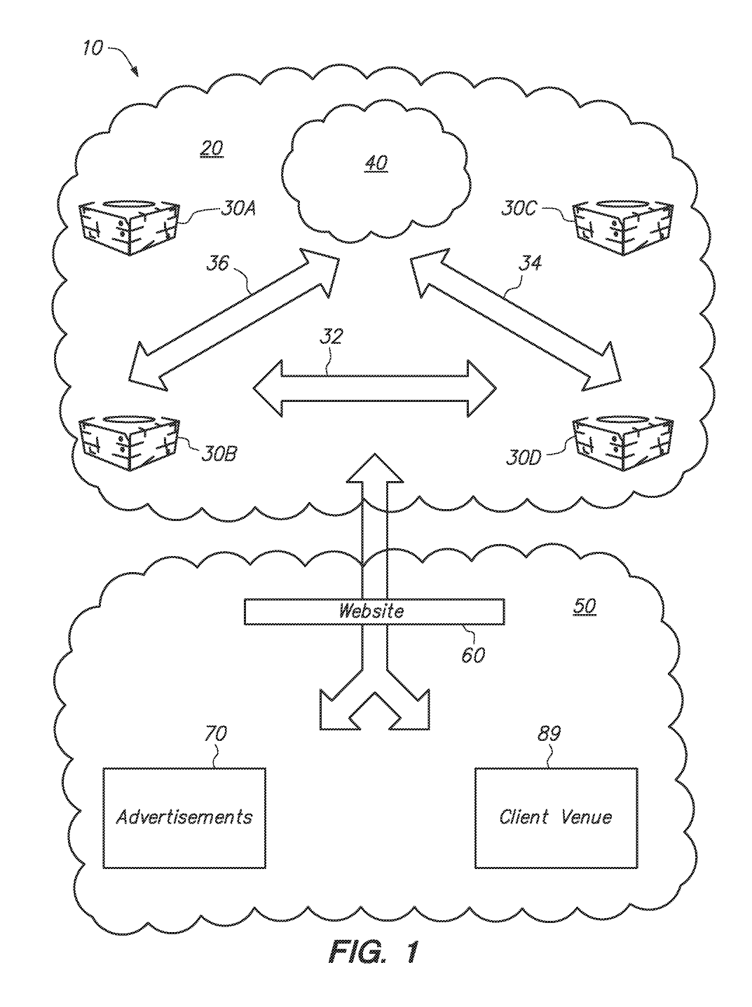

By way of example, and referring to FIG. 1, one embodiment of local area social network 10 comprises local venue 20 communicatively coupled to internet 50. Local venue 20 is a physical location that can house human users such as a bar, restaurant, or stadium. FIG. 1 offers hypothetical human users each having a computer peripheral device connected in a local area network: first computer peripheral device 30A, second computer peripheral device 30B, third computer peripheral device 30C, and computer peripheral device 30D. In some embodiments a computer peripheral device can include a laptop, cellular phone or tablet computer, for example.

The local area network comprises single shared screen 40 which can be used to display messages, pictures and videos displayed by a plurality of computer peripheral devices 30. For instance, second computer peripheral device 30B can send display data 36 to computer display 40 which will then be displayed in a feed 34 within the local area network on fourth computer peripheral device 30D. Alternately, second computer peripheral device 30B can send communication data 32 directly to fourth computer peripheral device 30D. To engage the local area network in local venue 20, each computer peripheral device must be on a shared internet connection, such as WiFi. In this regard, downloading a computer application can facilitate an exchange of communication data 32 and display data 34. However, this data is not unlimited and it can be censored by a filter on the web server.

The local area network is connected to internet 50 through website 60. Website 60 is hosted on a web server and then delivered to at least two kinds of clients. Client venue 89 is able to produce contact that can be pushed through website 60 into the local area network and onto single shared screen 40. Likewise, advertisers purchase advertisements and have the ability to push advertisements 70 through website 60 into the local area network and onto screen 40.

The website also permits local venue 20 to pay royalty fees in exchange for using the proprietary network. A locking out feature on the web server terminates operation of the proprietary network to those not making royalty payments.

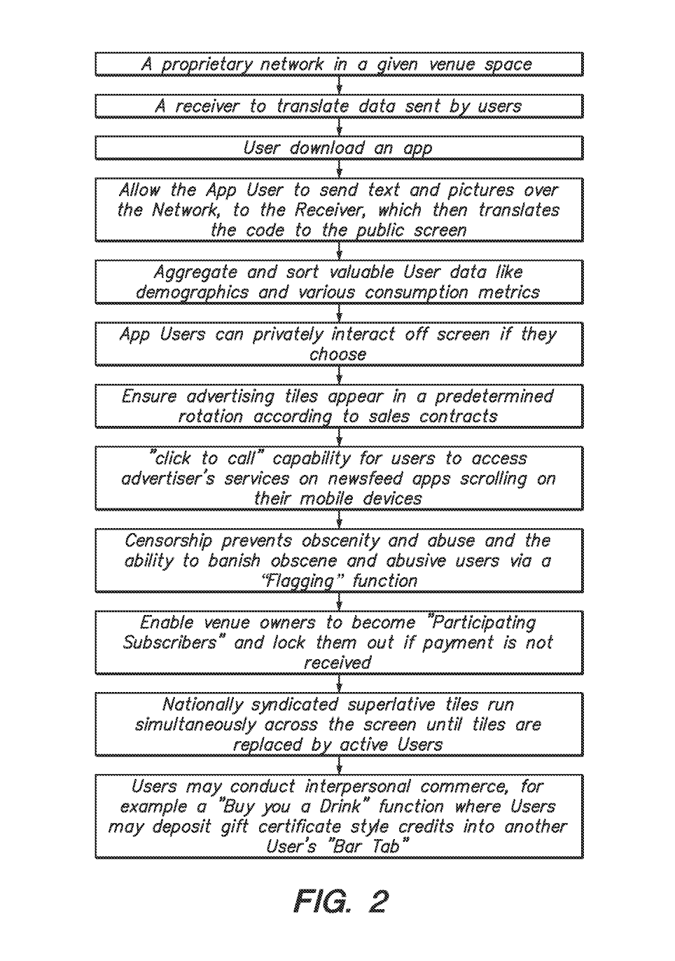

FIG. 2 shows a method for implementing the system described in FIG. 1. First, providing a proprietary network in local venue 20. Next, configuring a receiver to translate data sent by computer peripheral devices 30. Then, downloading an application on each computer peripheral device. After that, configuring the proprietary network to receive the data and to display the data on single shared screen 40. Following that, storing user data on the web server. Next, interacting between computer peripheral devices away from shared screen 40.

Then providing advertisements 70 to the shared screen. After that, permitting the computer peripheral device to call the advertiser with a click to call function. Following that, censoring inappropriate data sent to single shared screen 40. Next, locking out facilitates that fail to pay licensing fees from using the proprietary network. Then, providing default tiles to single shared screen 40 until users provide additional information. Following that applying a reward feature whereby users can purchase food or drink for clever messages sent to the single shared screen.

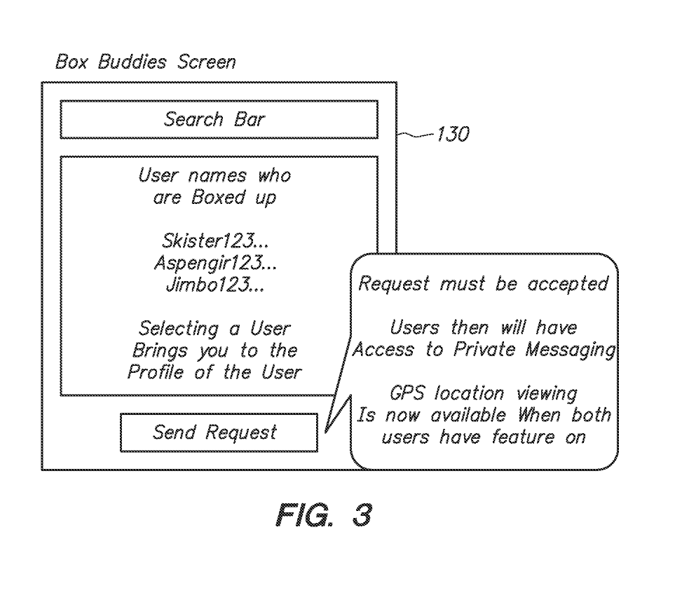

FIG. 3 provides one theory of how the user interface of the client application may work which can include processor instructions. A user can search for other users on the local area network unless the other users have enabled their own privacy settings to prevent this. Selecting a user brings up the profile of that user and provides some brief personal information such as name, interests, age, marital status and so on that might be useful in engaging the other user. To actually engage the user in a virtual conversation requires the user to accept an invitation. If that doesn't work, then the first user can simply walk up to the second user and start a conversation in a manner not explained in the prior art.

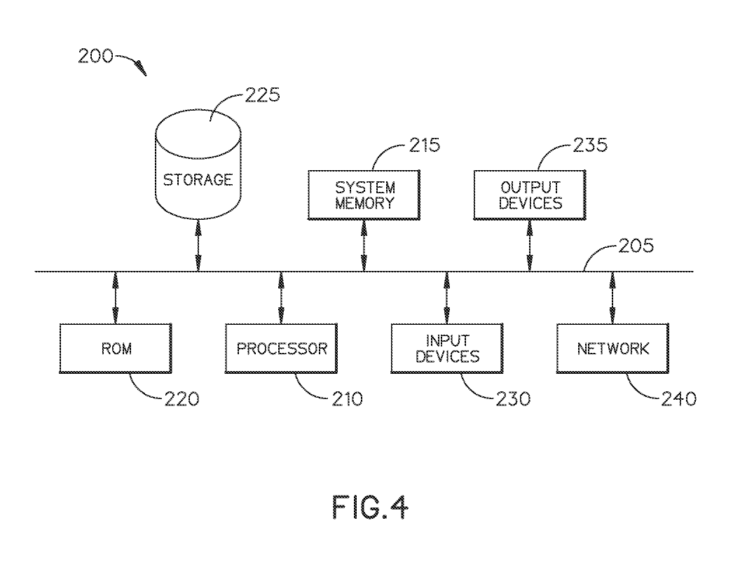

FIG. 4 conceptually illustrates an electronic system 200 with which some embodiments of the invention are implemented. The electronic system 200 may be a computer, phone, PDA, or any other sort of electronic device. Such an electronic system includes various types of computer readable media and interfaces for various other types of computer readable media. Electronic system 200 includes a bus 205, processing unit(s) 210, a system memory 215, a read-only 220, a permanent storage device 225, input devices 230, output devices 235, and a network 240.

The bus 205 collectively represents all system, peripheral, and chipset buses that communicatively connect the numerous internal devices of the electronic system 200. For instance, the bus 205 communicatively connects the processing unit(s) 210 with the read-only 220, the system memory 215, and the permanent storage device 225.

From these various memory units, the processing unit(s) 210 retrieves instructions to execute and data to process in order to execute the processes of the invention. The processing unit(s) may be a single processor or a multi-core processor in different embodiments.

The read-only-memory (ROM) 220 stores static data and instructions that are needed by the processing unit(s) 210 and other modules of the electronic system. The permanent storage device 225, on the other hand, is a read-and-write memory device. This device is a non-volatile memory unit that stores instructions and data even when the electronic system 200 is off. Some embodiments of the invention use a mass-storage device (such as a magnetic or optical disk and its corresponding disk drive) as the permanent storage device 225.

Other embodiments use a removable storage device (such as a floppy disk or a flash drive) as the permanent storage device 225. Like the permanent storage device 225, the system memory 215 is a read-and-write memory device. However, unlike storage device 225, the system memory 215 is a volatile read-and-write memory, such as a random access memory. The system memory 215 stores some of the instructions and data that the processor needs at runtime. In some embodiments, the invention's processes are stored in the system memory 215, the permanent storage device 225, and/or the read-only 220. For example, the various memory units include instructions for processing appearance alterations of displayable characters in accordance with some embodiments. From these various memory units, the processing unit(s) 210 retrieves instructions to execute and data to process in order to execute the processes of some embodiments.

The bus 205 also connects to the input and output devices 230 and 235. The input devices enable the person to communicate information and select commands to the electronic system. The input devices 230 include alphanumeric keyboards and pointing devices (also called “cursor control devices”). The output devices 235 display images generated by the electronic system 200. The output devices 235 include printers and display devices, such as cathode ray tubes (CRT) or liquid crystal displays (LCD). Some embodiments include devices such as a touchscreen that functions as both input and output devices.

Finally, as shown in FIG. 4, bus 205 also couples electronic system 200 to a network 240 through a network adapter (not shown). In this manner, the computer can be a part of a network of computers (such as a local area network (“LAN”), a wide area network (“WAN”), or an intranet), or a network of networks (such as the Internet). Any or all components of electronic system 200 may be used in conjunction with the invention.

These functions described above can be implemented in digital electronic circuitry, in computer software, firmware or hardware. The techniques can be implemented using one or more computer program products. Programmable processors and computers can be packaged or included in mobile devices with a computer application. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). A non-transitory computer readable medium is a medium which stores data semi-permanently and is readable by devices. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A local area social network, configured to enable a plurality of computer peripheral devices to show display data on a single shared screen; the local area social network comprising:
a proprietary network configured within a local venue;
the single shared screen communicatively coupled to the proprietary network;
a first computer peripheral device communicatively coupled to the proprietary network such that the display data sent from the first computer peripheral device is displayed on the single shared screen;
a second computer peripheral device communicatively coupled to the proprietary network such that communication data from the second computer peripheral device is displayed on the first computer peripheral device; and
a web server communicatively coupled to the proprietary network wherein the web server pushes data to the single shared screen and pulls user data sent from the first computer peripheral device and the second computer peripheral device.

2. The local area social network of claim 1, further comprising a website hosted on the web server wherein advertisers purchase advertisements that are pushed to the single shared screen.

3. The local area social network of claim 2, further comprising a filter such that obscene or inappropriate material, as defined by the local venue through the website, is censored and not displayed on the single shared screen.

4. The local area social network of claim 1, further comprising a computer application downloaded on to the first computer peripheral device and the second computer peripheral device to facilitate an exchange of the display data and the communication data.

5. The local area social network of claim 1, further comprising a locking out feature in the web server configured to prevent operation of the proprietary network when fees are not paid.

6. The local area social network of claim 1, further comprising a reward feature in the web server configured to enable a first user to encourage a second user for sending the display data.

7. A non-transitory computer readable medium configured with processor instructions to be executed by a processor on a first computer peripheral device; the processor instructions further comprising:
creating a profile with brief personal information; concealing at least some of the brief personal information with privacy settings;
connecting to a proprietary network within a local venue;
connecting to a second computer peripheral device on the proprietary network; sending communication data to the second computer peripheral device;
connecting to a single shared screen that is shared by the first computer peripheral device and the second computer peripheral device; and sending display data to the single shared screen.

8. The non-transitory computer readable medium of claim 7 wherein the processor instructions further comprise: rewarding a user of the second computer peripheral device for submitting the display data to the single shared screen.
